(19) United States
(12) Patent Application Publication
(10) Pub. No.: US 2012/0114962 A1
(43) Pub. Date: May 10, 2012

(54) SYSTEM AND METHOD FOR SYNTHESIZING CORE/ALLOY NANOSTRUCTURES

(75) Inventors: Mathew Maye, Binghamton, NY (US); Peter Njoki, Jamesville, NY (US); Wenjie Wu, Syracuse, NY (US); Hyunjoo Han, Syracuse, NY (US)

(73) Assignee: SYRACUSE UNIVERSITY, Syracuse, NY (US)

(21) Appl. No.: 13/291,376

(22) Filed: Nov. 8, 2011

Related U.S. Application Data
(60) Provisional application No. 61/411,135, filed on Nov. 8, 2010.

(51) Int. Cl. B32B 15/01; B22F 9/16

(52) U.S. Cl. 428/570; 75/351; 75/345

(57) ABSTRACT

A system and method to tailor the optical properties of nanomaterials using a core-alloy-shell nano-ultrastructure. Atomic diffusion is used at the nanoscale in order to process as-synthesized nanomaterials into core-alloy-shell architectures. The alloy formation is controlled by the deposition of the alloy solute atoms, and then by alloy interdiffusion of the solute into the core nanoparticle. By controlling temperature, it is possible to control how far the solute diffuses into the core, which in turn allows the tailoring of the optical response of the particle itself. The alloy formation and subsequent interdiffusion allows tailoring of the nanoparticle composition and ultrastructure, resulting in a dramatic tunability of the metal nanostructures surface plasmon response.

### CROSS-REFERENCE TO RELATED APPLICATIONS

The present application is a non-provisional of Provisional Application No. 61/411,135, filed on Nov. 8, 2010.

### BACKGROUND OF THE INVENTION

1. Field of the Invention

The present invention relates to nanoparticle formation and structure and, more particularly, a system and method for tailoring plasmon resonance using a core/alloy architecture.

2. Description of the Related Art

The synthetic methodology for colloidal nanoparticles, such as for metal nanoparticles (NPs) and semiconductive quantum dots (qdots), is a fascinating synergy of organic and inorganic wet-chemical reactions with solid-state processing. Much work has been accomplished since the seminal reports for both materials, and the knowledge base for wet chemical synthesis of nanomaterials and the remarkable electrical, optical, and catalytic properties have grown considerably. Up until only recently, fundamental studies have focused on developing protocols to fabricate particles that are crystalline, and possess controlled sizes and shapes with narrow distribution.

Future generations of nanoparticles will no doubt evolve from these classical examples, and one emerging trend in the field is the potential to “process” as-synthesized nanomaterials towards specific optical, electronic, catalytic, or morphological needs. A first example of this was the growth of metallic or semiconductive nanorods from spherical precursor seeds. Similarly, larger metal nanoparticles can be grown from small seeds, creating highly faceted mid-nano sized nanoparticles. Inorganic shells can also be deposited at synthesized cores; such as high band gap ZnS at CdSe qdots to improve photoluminescent quantum yields. Another intriguing example is the growth metallic shells at silica nanosphere cores, allowing for surface plasmon oscillation in the near infrared. Morphology can be further tuned in a number of ways, including photo-mediated mechanisms, as shown for silver NPs being evolved into controlled geometries, such as nanoprisms.

The composition of a NP can also be manipulated in a number of ways. In particular, the use of galvanic reactions at the nanoparticle interface has proven to be especially interesting. Using sacrificial palladium or silver nanocubes, hollow gold shells or cubic gold cages can be fabricated, the process of which can be followed in-situ by monitoring the rich plasmonic behavior. Another galvanic development is the ability for researchers to dramatically alter optical and catalytic properties via reversible ion exchange reactions in ionic qdot and qrod superlattices. Using Cu₂S or Ag₂Se qdots or qrods as templates, researchers have shown that Cd²⁺ or Pb²⁺ will undergo cationic exchange using galvanic potentials to form CdS and PbS of similar qdot size and morphology. In this example, lattice type, reduction potential, solvent, ligand to metal binding energies, defect concentrations, as well as atomic or defect diffusion rates drive the processing. In addition to chemical reactions at or within the nanoparticle core, the thermal processing of NPs is known to improve crystallinity and size distribution using tailored Oswald ripening.

The processing of nanomaterials may allow researchers to reach specific characteristics, morphologies, or phase regimes that are not accessible by simple synthesis alone, much the way that macroscopic materials must be processed for a specific application, such as for steels, plastics, and composites. While in bulk solids, the diffusion or interdiffusion of impurities such as dopants, defects, or atoms over nanoscale distances may not alter properties, similar diffusion, even at modest temperatures, will have profound effects for confined nanosystems, as observed in the previous examples. Thus, at the nanoscale, researchers can take advantage of enhanced diffusion rates, high surface free energies, and increased relative defect concentrations. These effects and the resulting changes to microstructure, lattice type and spacing, are emerging examples of the Kirkendall effect, which in addition to redox potential, atomic and defect diffusion at the NP interface and interior is key. It may also be possible to take advantage of atomic diffusion at modest temperatures for nanostructures with non-ionic lattices, using the metal phase behavior of binary or ternary alloys, for example. Such ability may be particularly useful when processing the optical properties of metal nanoparticles, allowing researchers to tailor plasmon response with corresponding phase behavior. However, this ability would require the precise control of thermal history and reproducibility of the processing step.

### BRIEF SUMMARY OF THE INVENTION

It is therefore a principal object and advantage of the present invention to provide a system and method for processing core/alloy nanomaterials.

In accordance with the foregoing objects and advantages, the present invention provides a system and method to tailor the optical properties of nanomaterials. In particular, the surface plasmon resonance signature of nanoparticles with diameters between 2-100 nm are controllably manipulated using a new core-alloy-shell nano-ultrastructure. The method of the present invention uses atomic diffusion at the nanoscale in order to “process” as-synthesized nanomaterials into “core-alloy-shell” architectures. The alloy formation (mixture of multiple metals) is controlled by first: the deposition of the alloy solute atoms, followed by alloy interdiffusion of the solute into the core nanoparticle. By controlling temperature, it is possible to control how far the solute diffuses into the core, which in turn allows the tailoring of the optical response of the particle itself. The alloy formation and subsequent interdiffusion allows us to tailor nanoparticle composition and ultrastructure, resulting in a dramatic tunability of the metal nanostructures surface plasmon response. This processing step, which involves the layer-by-layer formation of core/alloy/shell morphology, utilizes hydrothermal annealing to control solute deposition, as well as alloy thickness.

As a proof-of-principle system, the present invention was tested using an Au/Au_{X}Ag_{1-X}/Ag nanosystem, due in large part to its miscible phase diagram. The morphology of the nanostructures were characterized by HRTEM, STEM, and selective area EDX, which confirmed layer-by-layer growth and core/shell morphology. The resulting surface plasmon resonance signatures were modeled as a function of alloy or monometallic shell thickness, as well as alloy composition, using the discrete dipole approximation (DDA) method. The results strongly correlate with the experimental results, namely; that the alloy thickness and interdiffusion is highly tunable by thermal processing. This method may allow researchers a new way to tailor plasmon resonance in a precise manner.

The benefit of this approach is not only the ability to tailor the particles optics (which is a huge field known as “plasmonics”) but also opens up a new analytical approach in which researchers can model alloy behavior at the nanoscale using the optics as a signal. Moreover, this method is easily translated to a number of additional systems, including binary and ternary alloys, as well as miscible or immiscible phase diagrams

Future electronics, sensors, and imaging probes will not use electricity, instead they will use light to send signals. The present invention allows researchers a new way to tailor the wavelength (or “color”) of light that can be transmitted using plasmon resonance of nanoparticles. In addition to optoelectronics, researchers are also interested in using these classes of nanomaterials for “light harvesting” applications, such as those found in photovoltaics. In short, these materials allow researchers to “trap” light, which then has higher probability to be converted to electricity.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a schematic showing experimental design where (a) is a schematic blueprint of the dimensions and factors that govern the Au/Ag SPR response in the present study. Namely; core diameter (d_{C}), shell thickness (t_{S}), total NP diameter (d_{C+S}), core wavelength dependent dielectric constant (∈_{C}), shell wavelength dependent dielectric constant (∈_{S}), and surrounding ligand and media dielectric constant (∈_{M}) and (b) is an illustration of the processing method. Initial AuNP cores (i) are processed in the presence of Ag+ to hydrothermal conditions, which results in the first deposition of Ag⁰ followed by alloy interdiffusion at the NP interface, resulting in an intermediate alloy-shell (ii). Further addition of Ag layers (n) results in the growth of a Ag-shell (iii);

FIG. 2 is a series of graphs of in-situ temperature control and SPR monitoring. The in-situ temperature profiles at T_{H}=120 (a) and 160° C. (d) accompanied by representative sets of UV-vis results for the Au/Ag NP after increasing shell layer (n=1-12) at T_{H}=120 (b) and 160° C. (c). The spectra are offset for clarity. Insets: A schematic illustration describing the synthesis and morphological transformation of layer by layer shell deposition.

FIG. 3 is a series of micrographs of the Core/Shell and Core/Alloy/Shell Morphology and TEM results for Au/Ag fabricated at T_{H}=120° C. (a-e), and T_{H}=160° C. (f-g) for shell layers n=3, 7, 13, 17, 20. Statistical analysis (see FIG. 8-9) yields sizes of (a, n=3: 17.9±1.8 nm), (b, n=7: 19.5±2.3 nm), (c, n=10, 22.6±3.3 nm), (d, n=13, 24.9±5.0 nm), (e, n=17: 26.0±7.1 nm), (f, n=20: 33.5±6.3 nm), (g, n=3: 17.1±1.9 nm), (h, n=7: 20.3±2.3 nm), (i, n=10: 20.4±2.2 nm), (j, n=13: 20.7±2.4 nm), (k, n=17: 21.9±1.9 nm), (l, n=20: 22.9±3.1 nm). Inserts: magnified regions of interest at arbitrary scales. Original AuNP seed shown in FIG. 7 (n=0, 15.4±0.9 nm).

FIG. 4 is a series of graphs of diameter and SPR comparison where (a) A summary of the Au/Ag diameter (d_{C+S}) increase with shell layer (n) at both T_{H}=120 and 160° C. Error bars represent d_{C+S} standard deviation (σ), and (b) is the summary of λ_{SPR} dependence on shell layer (n) and processing T_{H}=60, 90, 120, 140, and 160° C., indicating the transition ( . . . ) from Au-SPR to Au/Au/Au_{X}Ag_{1-X}-SPR (o), and to Ag-rich Au/Au_{X}Ag_{1-X}/Ag-SPR (Δ).

FIG. 5 is a series of micrographs and a chart showing morphology and composition analysis where (a) is a representative STEM micrograph of the Au/Ag NP prepared at n=10 and T_{H}=120° C., (b-c) HRTEM micrographs of individual Au/Ag NPs, and (d-e) show corresponding selected area EDX spectra for the regions outlined for a single NP, and group of 5 NPs, revealing the presence of both Au and Ag within the NP itself.

FIG. 6 is a series of graphs of the Core/Shell and Core/Alloy Simulations showing (a) DDA simulations for phase segregated Au/Ag core/shell NPs with Au d_{C}=10.0 nm, and Ag t_{S}=1.0, 2.0, 3.0, 4.0, and 5.0 nm. Inset: Magnified region of interest for thin shell regions (t_{S}=0.25, 0.50, 1.0 nm), (b) DDA simulations for Au/AuₓAg₁₋ₓ core/alloy NPs at fixed t_{S}=1.0 and x=0.00, 0.05, 0.15, 0.25, 0.35, 0.50, (c) DDA simulations for Au/Au_{X}Ag_{1-X} core/alloy with x=0.50 and varied t_{S}=1.0, 2.0, 3.0, 4.0, and 5.0 nm (v). Surrounding dielectric medium is water and spectra offset for clarity only.

FIG. 7 is a representative TEM image of the original Au NP core and a series of charts of its statistical analysis showing an average size of 15.4±0.7 nm. The corresponding UV-vis SP band.

FIG. 8 is a representative TEM image and statistical analysis of Au/Ag fabricated at 120° C. for shell layers n=3, 7, 10, 13, 17, 20. Statistical analysis yields sizes of (a, n=3: 17.9±1.8 nm), (b, n=7: 19.5±2.3 nm), (c, n=10, 22.6±3.3 nm), (d, n=13, 24.9±5.0 nm), (e, n=17: 26.0±7.1 nm), (f, n=20: 33.5±6.3 nm). Corresponding UV-vis SP band are included.

FIG. 9 is a representative TEM image and statistical analysis of Au/Ag fabricated at 160° C. for shell layers n=3, 7, 10, 13, 17, 20. Statistical analysis yields sizes of (g, n=3: 17.1±1.9 nm), (h, n=7: 20.3±2.3 nm), (i, n=10: 20.4±2.2 nm), (j, n=13: 20.7±2.4 nm), (k, n=17: 21.9±1.9 nm) and (l, n=20: 22.9±3.1 nm). Corresponding UV-vis SP band are included.

FIG. 10 is a graph showing Alloy SPR Modeling: DDA simulations for Au/Au_{X}Ag_{1-X} alloy NPs with constant d_{C}=10.0 nm, and solid solution alloy composition of x=1.0, 0.95, 0.85, 0.75, 0.65, 0.50, 0.25, 0.00. Inset: Magnified region of interest for x=1.0, 0.95, 0.85, 0.75, 0.65, 0.50. Spectra of offset for clarity only.

FIG. 11 is (a) a schematic illustration of the synthesis procedures and core/alloy NP growth; (b-c) an in-situ temperature (b) and pressure (c) profiles measured during alloy deposition at T_{H}=120 and 160° C.

FIG. 12 is a graph of optical and morphological comparisons for Au/AuₓAg₁₋ₓ prepared at T_{H}=120° C. with x=0.15 (a), 0.50 (b), and 0.85 (c), with UV-vis (left), TEM micrographs (middle), and statistical analysis (right) comparing n=3 and 7 and UV-vis offset for clarity, identical scale bar.

FIG. 13 is a graph of optical and morphological comparisons for Au/AuₓAg₁₋ₓ prepared at T_{H}=160° C. with x=0.15 (a), 0.50 (b), and 0.85 (c), with UV-vis (left), TEM micrographs (middle), and statistical analysis (right) comparing n=3 and 7.

FIG. 14 is a graph of (a-b) a summary of the Au/AuₓAg₁₋ₓ d_{C+S} dependence on Ag content at T_{H}=120 (a) and 160° C. (b) for n=3 and 7, where the relationship between d_{C+S} and □_{SPR} at T_{H}=120 (c) and 160° C. (d).

FIG. 15 is a graph of the summary of the selective Ag etching of Au/AuₓAg₁₋ₓ/Ag to Au/AuₓAg₁₋ₓ fabricated at (a) T_{H}=120 and (b) 160° C., with BSPP ([BSPP]/[NP]=100,000) for x=1, 0.85, 0.5, and 0.15.

FIG. 16 is a graph of (a) a schematic illustration of the synthesis procedures and core/alloy NP growth; (b-d) optical photographs of Au/AuₓPd₁₋ₓ at n=0 (b), 5 (d), 10 (f), (e-f), where an in-situ temperature (e) and pressure (f) profiles measured during a alloy deposition at T_{H}=120 and 160° C.

FIG. 17 is a graph of UV-vis spectra (left), TEM micrographs (middle), and statistical analysis of size (right) for Au/AuₓPd₁₋ₓ prepared at T_{H}=120° C. with x=0.0 (a), 0.25 (b), 0.50 (c), and 0.75 (d), where the UV-vis are offset for clarity, micrographs have identical scale bar.

FIG. 18 is a graph of UV-vis spectra (left), TEM micrographs (middle), and statistical analysis of size (right) for Au/AuₓPd₁₋ₓ prepared at T_{H}=160° C. with x=0.0 (a), 0.25 (b), 0.50 (c), and 0.75 (d), where the UV-vis are offset for clarity, micrographs have identical scale bar.

FIG. 19 is a graph of HRTEM (a), STEM (b), and EDX (c) results for Au/AuₓPd₁₋ₓ prepared at T_{H}=160° C., n=7, and feed ratio x=0.00, where HRTEM and STEM images collected at different grid locations, analysis of EDX collected at region shown in b results in overall NP composition of Au₇₇Pd₂₃, and analysis of multiple regions (not shown) resulted in an average composition of Au₇₃Pd₂₇

FIG. 20 is a graph of (a) DDA of Au/Pd NP with Au d_{C}=12.8 nm and Pd shell at t_{S}=0.3, 0.6, 1.0, 1.8, and 2.5 nm; (b) DDA of Au/AuₓPd₁₋ₓNPs at constant t_{S}=2.4 nm at x=0.00, 0.25, 0.50, and 0.75.

### DETAILED DESCRIPTION OF THE INVENTION

To monitor changes to core/shell structure in our binary model system, a metallic nanoparticle system was chosen that has strong surface plasmon resonance characteristics, as well as a highly miscible binary phase diagram, namely gold/silver (Au/Ag). The Au/Ag nanoparticle system has been explored previously by researchers using different synthetic strategies, including; radiolytic techniques, laser irradiation, galvanic replacement, co-precipitation, and thermal evolution.

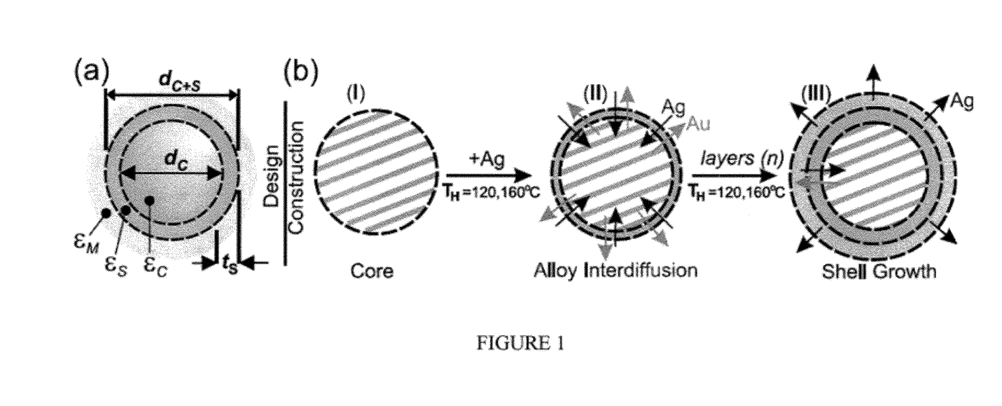

The surface plasmon resonance (SPR) band of a core-shell nanomaterial is derived from the size, shape, structure, composition, and surrounding medium of the nanostructure, thus making Au/Ag an attractive test case. In general, the SPR arises from the collective oscillation of conduction electrons in the presence of electromagnetic radiation, which for nanoscale materials is highly localized and conveniently occurs in the visible or NIR spectrum. FIG. 1a shows the design parameters tailored in our study. The core of known diameter (d_{C}) and wavelength dependent dielectric constant (c_{C}), is encased in a shell of a second material (∈_{S}) with fine-tuned thickness (t_{S}). Moreover, the colloidal NPs are suspended in a water dielectric medium (∈_{M}). The influence of the immediate ligand shell is not accounted for in these systems due in large part to the small and weakly chemisorbing ligands employed.

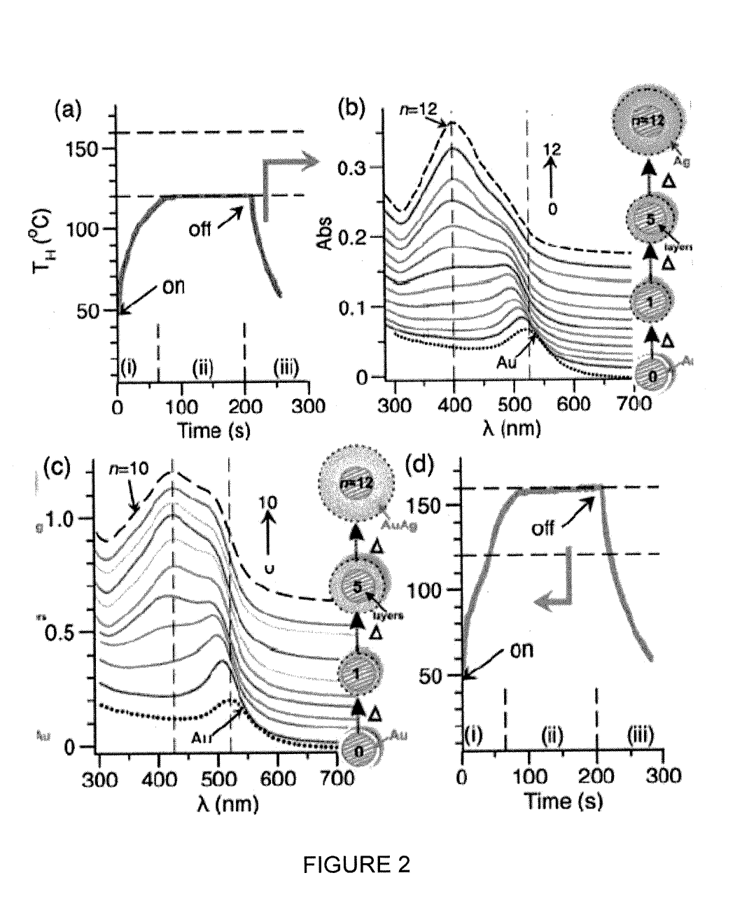

The success of any processing procedure is judged on the fidelity in which one can tailor properties or morphology. In the present system, this is shown by the tailoring of shell type, and thickness. For control, a novel microwave irradiation (MWI) based hydrothermal processing method was developed to allow for the temperature (T_{H}) dependent deposition of Ag at AuNP core seeds. The use of a synthetic reactor for dynamic MWI in our system facilitates fine-control of heating and cooling rates, processing temperature, as well as in-situ monitoring of reaction temperature and pressure (43). FIGS. 2a and 2d shows the in-situ temperature profiles during a typical Ag-layer deposition. The system undergoes rapid heating, with rates ˜1° C./s (region-i), followed by a stable processing temperature (region-ii), from which the system is dynamically cooled via compressed gas (region-iii). Each step is computer controlled, with temperature being monitored by an integrated infrared probe, which in turn allows for feedback between temperature and MW power. This further allows for a highly reproducible thermal history between samples and systems, aiding reproducibility of the reported layer-by-layer growth.

An aqueous dispersion of citrate-capped 15 nm gold cores (Au, d_{C}=15.4±0.7 nm) is used at first and then shells of Ag are deposited in controllable sub nanometer layers (n). Here, silver reduction is achieved using a minimum amount of reducing agent, sodium citrate (Cit), which was found only to reduce silver ions at the hydrothermal temperatures. Moreover, silver ions are added and reduced in a step-by-step (e.g. layer-by-layer) fashion at a ratio (r=Ag⁺/[Au]) required to deposit a 0.25-0.50 nm thick shell (t_{S}). It is important to note, that in the present system, the addition of Ag⁺ does not induce galvanic replacement with interfacial Au⁰; as the Au⁺|Au redox couple has a standard reduction potential (E⁰=1.69 V) that is much higher than Ag⁺|Ag (E⁰=0.799 V), indicating a thermodynamically unfavorable displacement.

By processing at hydrothermal temperatures (T_{H}), a highly controllable and unique optical and morphological property emerges from the Au/Ag system. At T_{H}⁼120° C. for 3 min we observed a colorimetric change from the ruby-red color of the AuNP to a reddish-orange after only one layer (n=1), then gradually to orange at n=3-5. Ultimately, the color evolves to dark yellow at increased shell layers (n>5). Importantly, the solution itself remains optically clear and stable, suggesting growth of the new Ag-rich nanostructure, and lack of aggregation. Control experiments subjecting the Au to these conditions without AgNO₃ addition resulted in a stable Au SPR with no change to morphology or concentration. To follow this transformation, we employed UV-vis, and transmission electron microscopy (TEM).

The SPR progression at T_{H}=120° C. shown in FIG. 2b reveals three distinct features that are a function of shell type, thickness, and temperature. First, at initial shell layers (n=1-4), we observe a novel blue-shift of SPR wavelength (λ_{SPR}) from 522 to 498 nm. Second, the λ_{SPR} shift is subsequently followed by the growth of a second SPR centered at 400 nm. Third, the SPR at 400 nm increases in extinction at n>5, with a slight red-shift consistent with the growth of a larger Ag NP. This SPR response is qualitatively in agreement with the formation of a Ag-rich nanostructure (34-36, 38-42). In addition to the λ_{SPR} shift, a ˜3× increase in extinction coefficient is observed, an added attribute to an increasingly Ag-character. However, a close investigation of the SPR characteristic indicates a more intriguing two-step growth mechanism of the Au/Ag particles. For instance, the initial blue shift in λ_{SPR} from 518 to 498 nm, as well as the single-peak nature of its SPR, strongly suggests not simply the formation of a phase segregated core/shell nanostructure, but the initial formation of a Au_{X}Ag_{1-X} alloy skin.

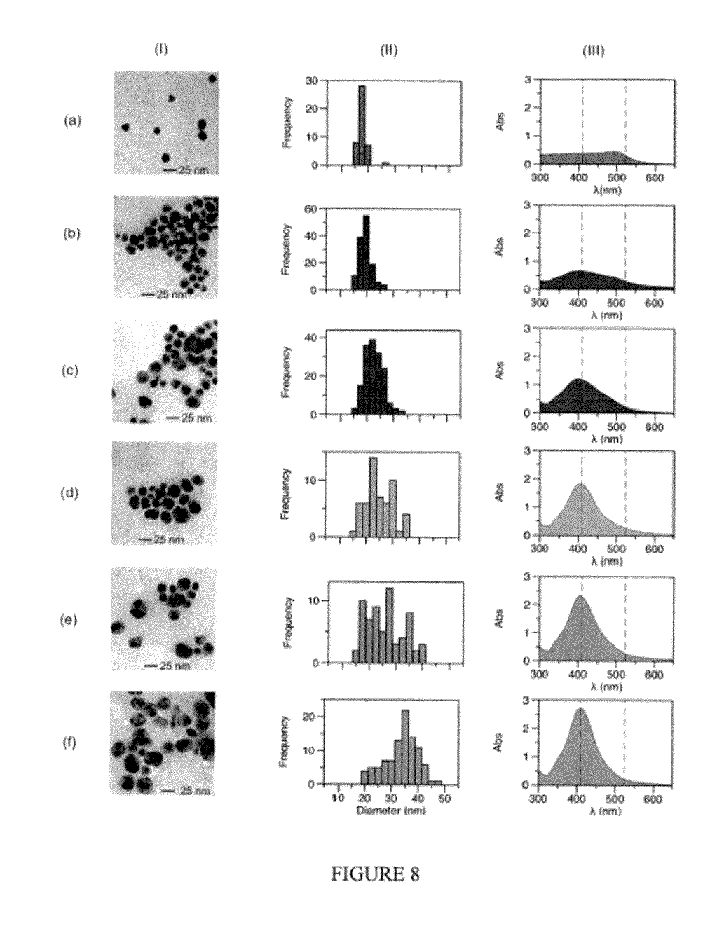

It has been shown that the λ_{SPR} for a binary Au_{X}Ag_{1-X} NP is linearly correlated to composition, with higher Ag concentrations exhibiting blue shifted SPR. Importantly, such solid-solution alloys are known to maintain single SPR characteristics. For instance, El-Sayed and co-workers have synthesized AuₓAg₁₋ₓ and showed a near linear SPR for particles of similar core-sizes. As well, Murphy and co-workers investigated SPR response to alloy composition, and revealed that a physical mixture of Au and AgNPs cannot account for such SPR response (44). In addition, the spontaneous alloying of AuAg nanoparticles with d<5 nm showed composition dependent SPR. The extent of the shift, as well as the extinction is further related to size and shape. The blue-shift of a single SPR band observed in FIG. 2b for the initial layers (n=1-4) largely follow this alloy trend. In the second step, an increasingly thick Ag shell is grown, which results in the sequential growth of a λ_{SPR} centered at 400 nm, which further shields the core and alloy intermediate shell, resulting in the shoulder at 2490 nm. At thicker shells at n>11, only a single SPR is observed at ≈410 nm (see FIG. 8).

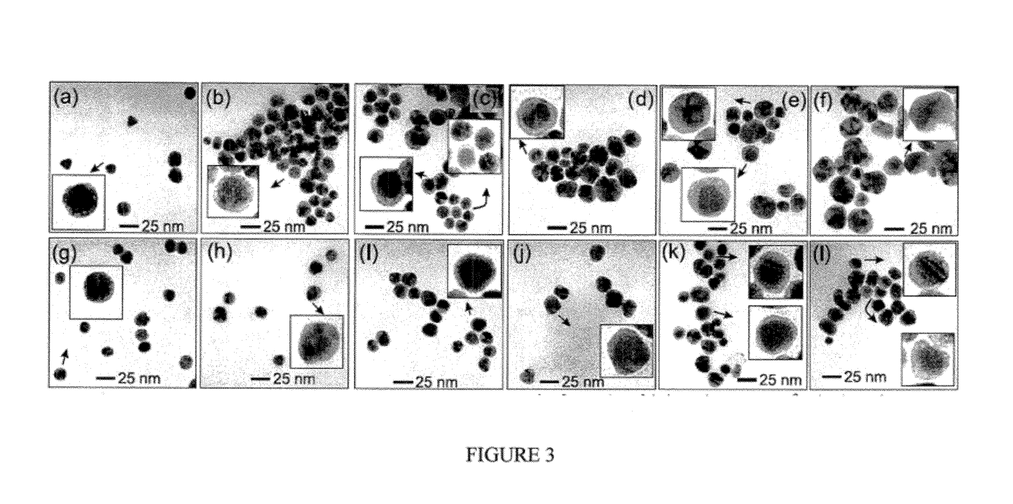

This optical behavior was correlated with morphology change using TEM (FIG. 3), which confirmed the growth of Au/Ag NPs as a function of deposition layer, n. From an initial AuNP with d_{C}-15.4±0.7 nm, a growth to core+shell diameters, d_{C+S}=17.9±1.8 (a), 19.5±2.3 (b), 22.6±3.3 (c), 24.9±5.0 (d), 26.0±7.1 (e), and 33.5±6.3 nm (f) was measured for n=3, 7, 10, 13, 17 and 20, respectively at T_{H}=120° C. It is interesting to note that the Au/Ag maintain high monodispersity values at n=1-4, but become increasingly polydisperse at larger n (thicker t_{S}), especially at n>11. A close inspection of the TEM images (see insets) reveal that a high percentage of the NPs show clear core/shell structures, especially at n>7, and that shell growth does posses some dipersity and anisotropy in terms of the core position and shell thickness.

As hypothesized, the SPR response, d_{C+S}, and alloy formation was found to be highly susceptible to processing T_{H}. FIG. 2c shows the UV-vis profile of Au/Ag prepared under identical conditions except a raise to T_{H}=160° C. Such temperature increase and control was trivial using our MWI based method, as shown by the temperature profiles (FIG. 2d). Compared to the Au/Ag processed at 120° C., we observe a new SPR signature. A major characteristic of this difference is the significant shoulder observed at ≈480 nm, along with a lower energy λ_{SPR} centered at ≈425 nm. In addition, only a minimal increase in extinction coefficient was observed. These results suggest either a larger role of Au in the new nanostructure, or the presence of a thick alloy intermediate layer, as compared to the previous T_{H}=120° C. case.

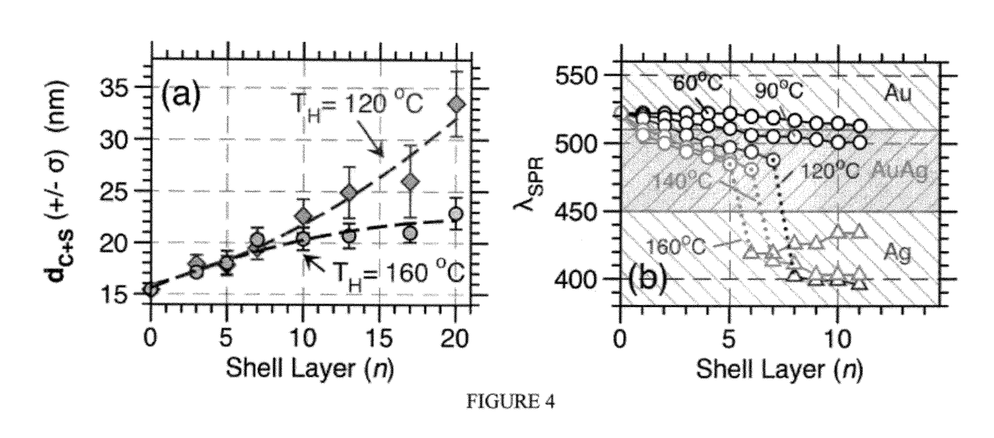

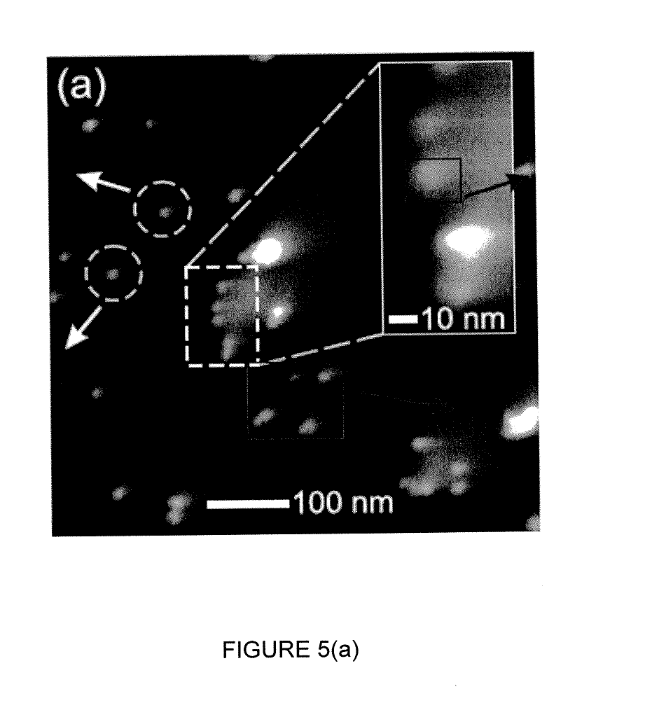

The TEM micrographs for Au/Ag prepared at T_{H}=160° C. are shown in FIG. 3g-l (lower panel). We observed two main differences when compared to T_{H}=120° C. (top panel). First, samples prepared at elevated T_{H} show improved monodispersity and smaller sizes at high n. Second, the visualization of a core/shell morphology is largely limited to n>11, which suggests a higher degree of alloying at intermediate layers as a result of the T_{H} increase (see below). FIG. 4 summarizes these TEM and SPR observations by showing the relationship between d_{C+S} (a) and λ_{SPR} shift (b) with n and processing T_{H}. Interestingly, the NPs show very similar d_{C+S} up to n˜7, which then diverge in a counterintuitive trend that shows larger diameters at low T_{H}, whereas higher T_{H} shows smaller diameters and improved monodispersity (as represented by error bars). The λ_{SPR} shift was also found to be highly sensitive to T_{H} (FIG. 4b), with increased T_{H} resulting in more rapid initial SPR blue shift. On the other hand, control experiments at T_{H}<100° C. suggest much slower alloy diffusion, as evidenced by minimal λ_{SPR} blue-shift (FIG. 4b).

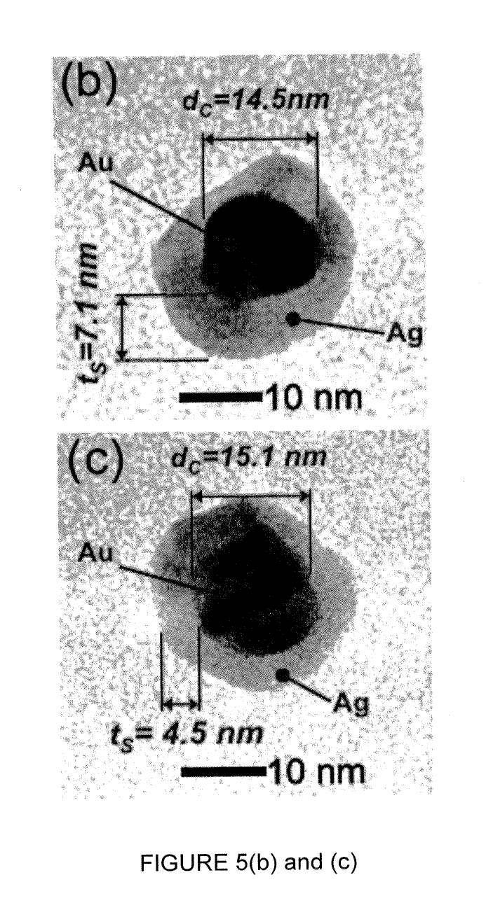

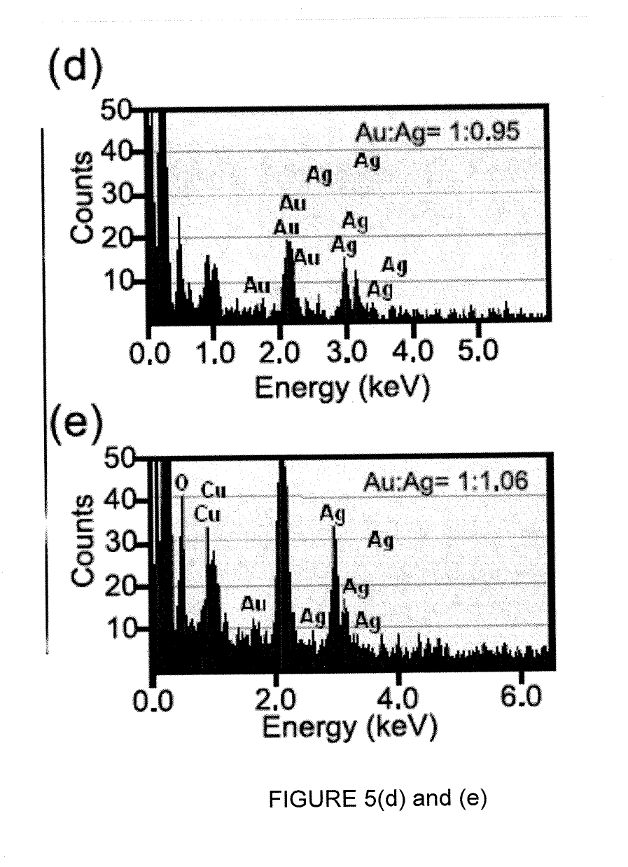

Further evidence of Ag shell growth and core/shell structure was provided by high resolution TEM (HRTEM) and scanning TEM (STEM) in combination with selective area energy dispersive x-ray analysis (EDX). FIG. 5a shows a representative STEM image for typical Au/Ag prepared at T_{H}=120° C. and n=10. A HRTEM image of selected Au/Ag (FIG. 5b-c) show clear core/shell morphology with dimensions that agree well with the growth mechanism and protocol design. The NP composition was probed by selective area EDX, and obtained for a single (FIG. 5d) and grouping (FIG. 5c-d) of NPs that provide clear evidence of both Au and Ag L-edge binding energies at ≈2.1 and ≈3.0 keV respectively. The quantitative analysis of the EDX reveal a Au:Ag composition ratio of 1:0.95, and 1:1.06 respectively.

A fundamental aspect of this system is the dramatic changes to the SPR response (FIG. 2), from relative minor changes to NP size and shape (FIG. 3). Thus, the internal structure and composition of the core/alloy/shell is critical for the SPR. This suggests that the modeling the SPR band may allow for gaining deeper structural insights into the nanostructure itself. For this the discrete dipole approximation (DDA) method was employed. In DDA, a numerical solution is defined by dividing a NP into elemental cubic volumes that are characterized by their coordinates within the NP, and their subsequent polarizability (45-47). Thus, each unit can be treated as a dipole, the collection of which have shown great accuracy in describing not just SPR λₘₐₓ, but also the entire shape of the SPR band. Such treatment is critical for increasingly complex plasmonic structures, and has been employed recently to explore triangular silver nanoprisms and nanostructures, as well as AuAg nanoboxes.

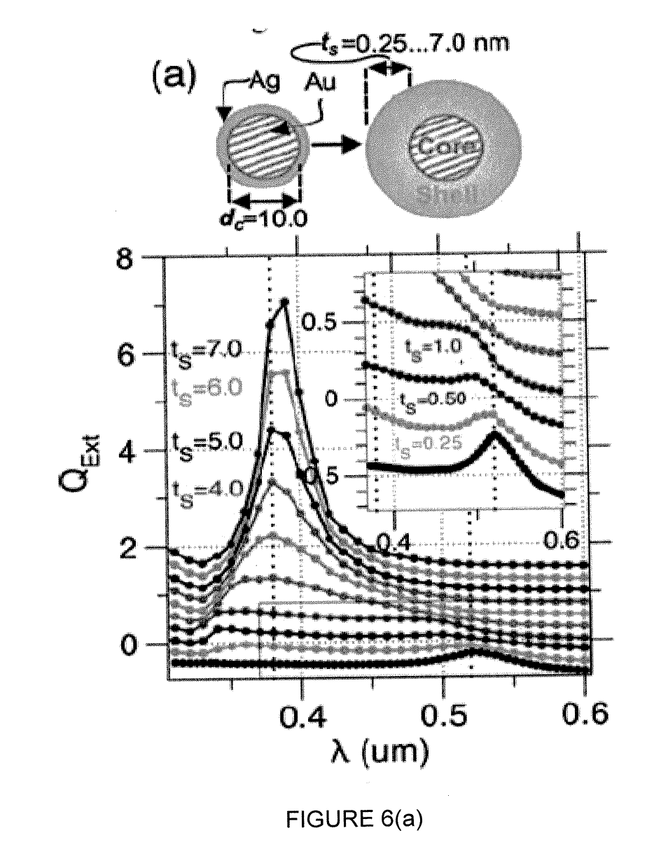

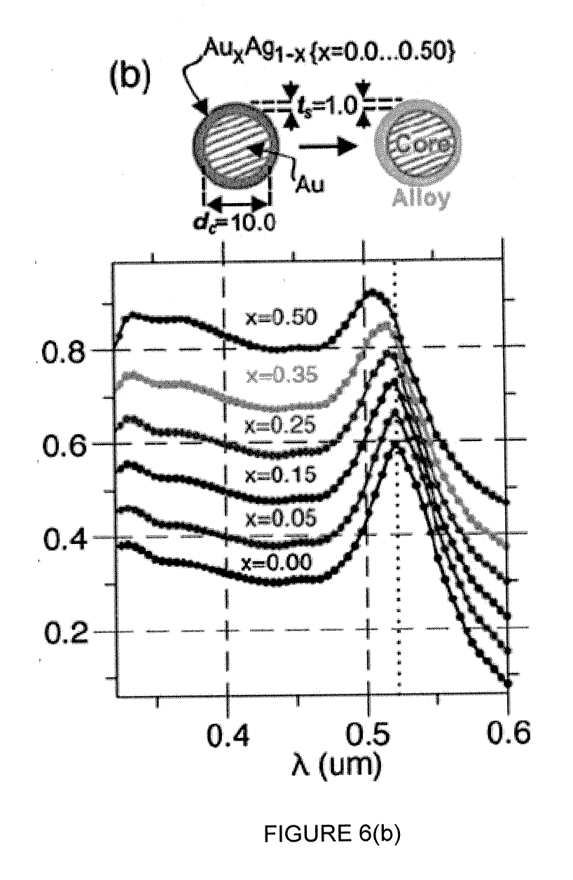

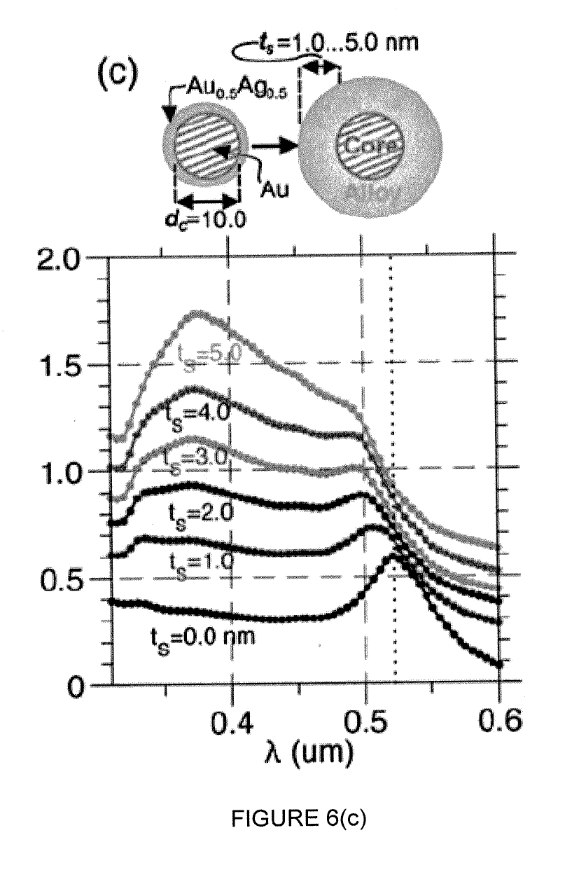

FIG. 6 shows the results of a series of DDA calculations for an idealized phase segregated core/shell (a), as well as a core/alloy NP (b-c). For a spherical AuNP with d_{C}=10.0 nm and increasing number of concentric Ag shells with t_{S}=0.25, 0.50, 0.75, 1.0-7.0 nm the simulations reveal a significant λ_{SPR} blue-shift, with the immediate emergence of a second Ag-based SPR at ≈390 nm (FIG. 6a). An increase in t_{S} from 1.0 to 7.0 nm results in screening of the Au core, and a predominantly Ag SPR that shows a subtle red-shift with increasing thickness (42). A closer look at sub nanometer shell thickness, t_{S}=0.25, 0.50 nm (FIG. 6a—inset), shows an intermediate λ_{SPR} shift, but still accompanied by a second λ_{SPR} at ≈350 nm. These core/shell simulations show two key characteristics. First the existence of two SPR is confirmed, one attributed to the core, and the second to the shell, and second; that the increasing shell thickness in the phase segregated model is clearly in agreement with the experimental trends at n>4 (FIG. 2b). However, the results cannot completely replicate the experimental observations of the initial λ_{SPR} blue-shift of a single SPR, such as that observed for n=1-4, nor the overall SPR response for the T_{H}-160° C. system (FIG. 2c), suggesting formation of an intermediate AuₓAg₁₋ₓ alloy layer of varied composition and or thickness.

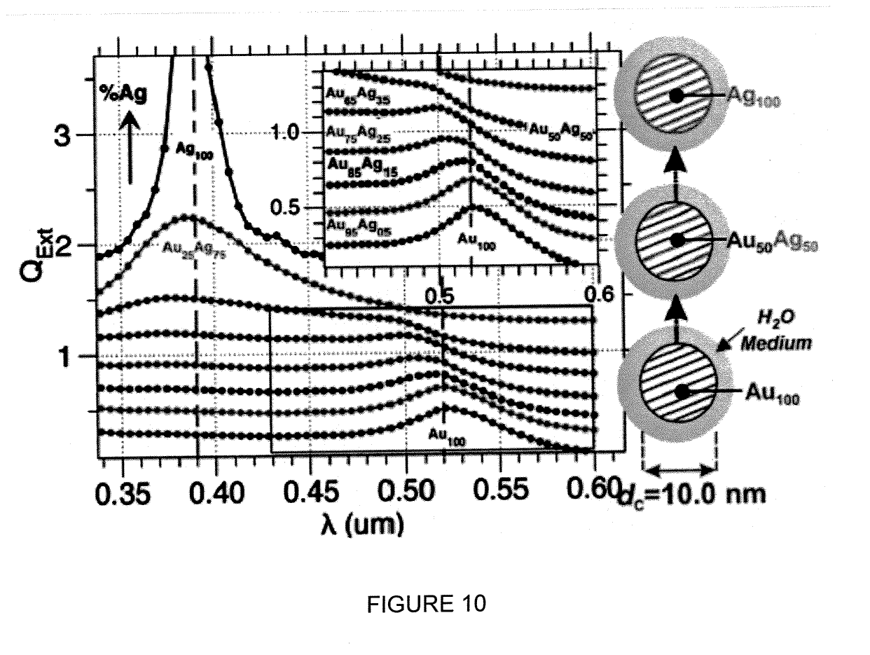

To investigate this postulated alloy shift, we performed similar DDA calculations using an alloy (FIG. 10) and core/alloy model (FIG. 6b-6c). Alloy simulations for a d_{C}=10.0 nm AuₓAg₁₋ₓ binary NP of x=0.05, 0.15, 0.25, 0.35, 0.50, 0.70, and 1.0 were first performed (FIG. 10). For this we calculated dielectric constants for a binary alloy by linear combination of individual Au and Ag values, namely: ∈_{Alloy}(x,λ)=x_{Ag}∈_{Ag}(λ)+(1−x_{Ag})∈_{Au}(λ); where x_{Ag} is the volume fraction of Ag, ∈_{Au} and ∈_{Au} are the wavelength dependent dielectric constants for gold and silver respectively. Such a method was recently described by El-Sayed and co-workers (34-36), and some theoretical work has been done recently (49). A similar approach was also used recently for alloy nanorods (50). The Au_{X}Ag_{1-X} simulations were then employed for a core/alloy DDA calculation.

FIG. 6b shows the modeled effect of an Au/Au_{X}Ag_{1-X} core/alloy NP with a fixed t_{S}=1.0 nm and varied alloy composition, x=0.00, 0.05, 0.15, 0.25, 0.35, 0.50. The resulting DDA spectra reveal a subtle blue-shift in λ_{SPR}, the magnitude of which is linearly dependent on the molar fraction of Ag in the 1 nm shell. Moreover, the spectra maintain the single SPR nature. This shift is consistent with that experimentally observed at n=1-4 for both T_{H}=120 and 160° C., again indicating the formation of an alloy layer. We further investigated the effect of an alloy shell by simulating a Au/Au_{0.5}Ag_{0.5}NP with a d_{C}=10.0 nm Au core with increasing alloy shell thickness of t_{S}=1.0-5.0 nm (FIG. 6c). The simulation shows intriguing results that are consistent with the experimental data, namely; the intermediate λ_{SPR} blue shift of a single SPR resonance, particularly up to t_{S}=1.0-2.0. It is also interesting to note, that at large t_{S} the overall SPR qualitatively agrees very well with the response observed for the T_{H}=160° C. system (FIG. 2c), suggesting the main difference between the two systems to be an increased alloy layer thickness.

These results indicate that alloying of the core/shell interface is highly sensitive to temperature, suggesting an atomic diffusion mechanism. Since both Ag-to-core, and Au-to-shell diffusion is possible, as well as the high likelihood of surface defects at the initial Au-core interface (38-41), the initial Ag-shells at n=1-4 likely undergoes spontaneous alloying, the thickness of which is ultimately limited by diffusion rates, which is tailored by processing temperature (FIG. 1b). The subtle differences between the experimental UV-vis and the DDA plasmon modeling are attributed to variation between the experimental and model NP dimensions, as well as the high likelihood of the intermediate alloy layer possessing a composition gradient between the Au-rich core, and Ag-shell, as shown in the initial Kirkendall studies (25). Nonetheless, these results show that by controlling core/shell dimensions and alloy formation, researchers now have a new approach towards tuning the plasmon response towards specific application goals. On the other hand, these results and modeling also suggest the exciting possibility of further tailoring the system using a purposely-deposited alloy shells or gradients, in-which alloy composition and phase behavior can be explored and modeled by the SPR response, which is part of our ongoing work.

In summary, we have shown the ability to deposit controlled thicknesses of Ag shells at Au nanoparticle cores. The growth of the shells into core/shell nanostructures proceeds under a core/alloy/shell growth mechanism, which is highly sensitive to temperature, suggesting an atomic diffusion and alloying mechanism at or within the NP itself. This growth allows for the engineering of surface plasmon response in ways that are difficult using conventional approaches. Moreover, the plasmon response itself provides a valuable look into the particle ultrastructure, with DDA modeling elucidating finer details not observed by TEM. Such high-fidelity control of the SPR and morphology may find utility in future work using these nanoparticles as plasmonic antenna, metamaterials, optical probes, and surface enhanced Raman substrates.

### Example 1

### Experimental Details

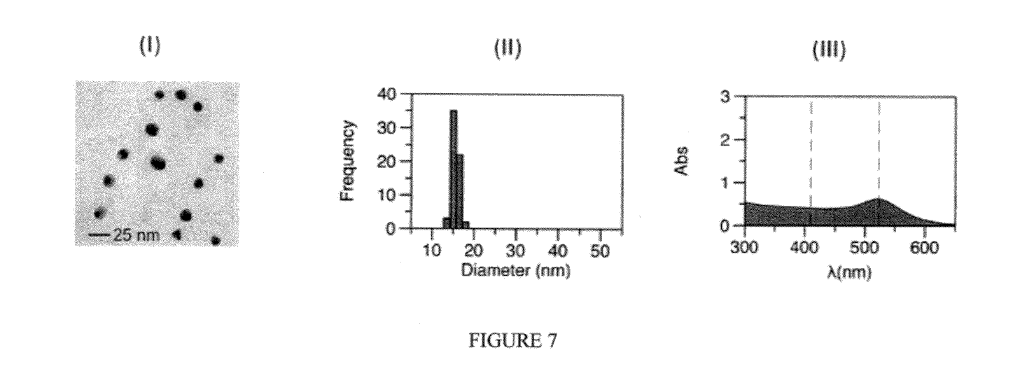

Synthesis of Gold Nanoparticle Cores. Gold nanoparticles (Au, 15.4±0.7 nm) were synthesized by a slightly modified citrate (Cit) reduction procedure (FIG. 7). Briefly, an aged 1 mM HAuCl₄ solution was heated to ˜95° C. for 30 minutes. To this solution a warm 38 mM trisodium citrate solution (10 ml) was added in one aliquot. Upon initial color change to red, the solution was then immediately cooled to ˜80° C. and annealed for 1 hr. The sample was then let to cool naturally to room temperature and allowed to stir overnight. The solution was then stored protected from light. The Au concentrations were calculated via a measured extinction coefficient of 1.25×10⁸ L mole⁻¹ cm⁻¹.

Layer-by-Layer Silver Shell Growth: We begin with Au cores synthesized above, and deposit shells of Ag in controllable sub nanometer layers (n). Here, silver (AgNO₃) reduction is achieved using a minimum amount of reducing agent, sodium citrate (Cit), which was found to best reduce the silver ions at the hydrothermal temperatures employed. Moreover, silver ions are added and reduced in delicate step-by-step (e.g. layer-by-layer) fashion at a ratio (r=[Ag⁻]/[Au]) required to deposit a 0.25˜0.50 nm thick shell (t_{S}), based on model calculations for volume change due to shell growth at a constant Au-core diameter and NP concentration. For example, in a typical experiment, a 2.2 mL ultrapure water (18.2 MΩ) solution of Au ([Au]=9.3 nM), trisodium citrate ([Cit]=1.36 mM), and AgNO₃ ([AgNO₃]=0.045 mM) are hermetically sealed in 10 mL glass microwave reaction vessels. Next, the sample is rapidly heated to hydrothermal temperatures (T_{H}) and pressures (P_{H}) using computer controlled microwave irradiation (MWI). A typical reaction time is 5 minutes. After each layer deposition (heating cycle), a 100 uL aliquot was collected for UV-vis and TEM analysis, and a fresh 100 uL aliquot of 1 mM AgNO₃ is added. The process is then repeated an n number of times, resulting in the growth of the Ag-rich core/shell nanostructure. The final Au/Ag products were stored in the reaction mother liquor, and protected from light. Under these storage conditions, the Au/Ag NPs were stable indefinitely.

Instrumentation:

Synthetic Microwave Reactor: A Discovery-S (CEM Inc.) synthetic microwave reactor was employed. The instrument is computer controlled, and operates at power values between 0-300 W; temperatures ranging from 30-300° C., and pressures from 0-200 PSI. Temperature is monitored in-situ during synthesis via the use of an integrated IR-sensor, or via an immersed fiber optic temperature probe. The instrument is equipped with an active pressure monitoring system, which provides both pressure monitoring and added safety during synthesis. Taken together, this combination allows the MWI power to be dynamically attenuated by temperature feedback measured via the integrated infrared detector or fiber optic probe, allowing for fine control of annealing temperature, the ability to rapidly achieve hydrothermal conditions, as well as control of heating and cooling rates. Pressure rated glass reaction vials with volumes of 10 or 35 mL were employed during synthesis. Active cooling was provided by the influx of the MW cavity with compressed N₂, which rapidly cools the sample at a controlled rate.

UV-visible Absorption (UV-vis): The UV-vis measurements were collected on a Varian Cary100 Bio UV-vis spectrophotometer between 200-900 nm. The instrument is equipped with an 8-cell automated holder with high precision Peltier heating controller.

Transmission Electron Microscopy (TEM): TEM measurements were performed on either a FEI T12 Twin TEM operated at 120 kV with a LaB6 filament and Gatan Orius dual-scan CCD camera (Cornell Center for Materials Research), or a JEOL 2000EX instrument operated at 120 kV with a tungsten filament (SUNY-ESF, N.C. Brown Center for Ultrastructure Studies). Particle size was analyzed manually by modeling each qdot as a sphere, with statistical analysis performed using Image) software on populations of at least 100 counts.

High Resolution Transmission Electron Microscopy (HRTEM): HRTEM measurements were performed at the CCMR on a FEI T12 Spirit TEM/STEM operated at 120 kV with a field emission source and a SIS Megaview III CCD camera. The instrument is equipped with both a brightfield and darkfield HAADF STEM detector. The selective area energy dispersive X-ray analysis (EDX) was performed in-situ to STEM visualization, using an EDAX Genesis X-ray detector with internal elemental calibration.

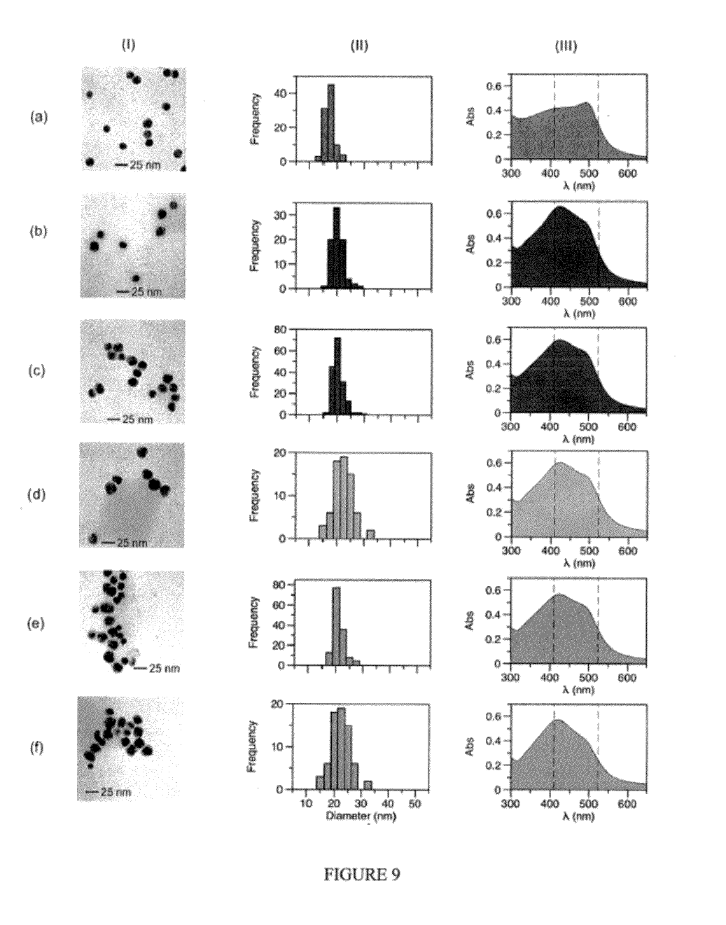

DDA Modeling: The NP and core/shell NP surface plasmon resonance (SPR) extinction spectra was modeled using the discrete dipole approximation (DDA) method developed by Draine and Flatau (FIG. 8). The open source software package DDSCAT 7.07 (FIG. 9) was employed on a Linux workstation equipped with an Intel i7 processor and 12 GB SDRAM running Ubuntu. Isotropic cores were calculated via the ELLIPSOID DDSCAT routine, whereas core/shell morphologies were calculated via the CONELLIPS routine with defined core diameter, and shell thicknesses. Typical calculation times ranged from minutes for simple structures, to 12-24 hr for large diameters or complex core/shell geometries. In DDA (eq. 1) a numerical SPR solution is defined by dividing a NP into elemental cubic volumes that are characterized by their coordinates within the NP, and their subsequent polarizability (FIG. 10). Thus, each unit can be treated as a dipole, the collection of which have shown great accuracy in describing not just SP but also the entire shape of the SP band (i.e. accurate NP mapping):

$${σ}_{ext} = \frac{4 π k}{{\vert {E}_{0} \vert}^{2}} {\sum }_{j = i}^{N} ( {E}_{loc , J}^{*} \cdot {P}_{J} ) \qquad ( 1 )$$

Here, the SPR extinction (σₑₓₜ, Qₑₓₜ) is related to the sum of N discrete dipole vectors (fields) E* and P_{J}, corresponding to electrical field and polarization, and k is a constant (k=m₀(2π/λ); m₀=related to material index of refraction (eqn. 1). Wavelength dependent dielectric tables for both Au and Ag were generated using well-established optical constants (S5). For the Au_{X}Ag_{1-X} solid solution alloys, we calculated dielectric constants for a binary alloy by linear combination of individual Au and Ag values, namely: ∈_{Alloy}(x,λ)=x_{Ag}∈_{Ag}(λ)+(1−x_{Ag})∈_{Au}(λ); where x_{Ag} is the volume fraction of Ag, ∈_{Au} and ∈_{Au} are the wavelength dependent dielectric constants for gold and silver respectively. Such a method was recently described by El-Sayed and co-workers (S6), and some theoretical work has been done recently (S7). A similar approach was also used recently for alloy nanorods (S8). The Au_{X}Ag_{1-X} simulations were then employed for a alloy core, and core/alloy DDA calculations.

### Example 2

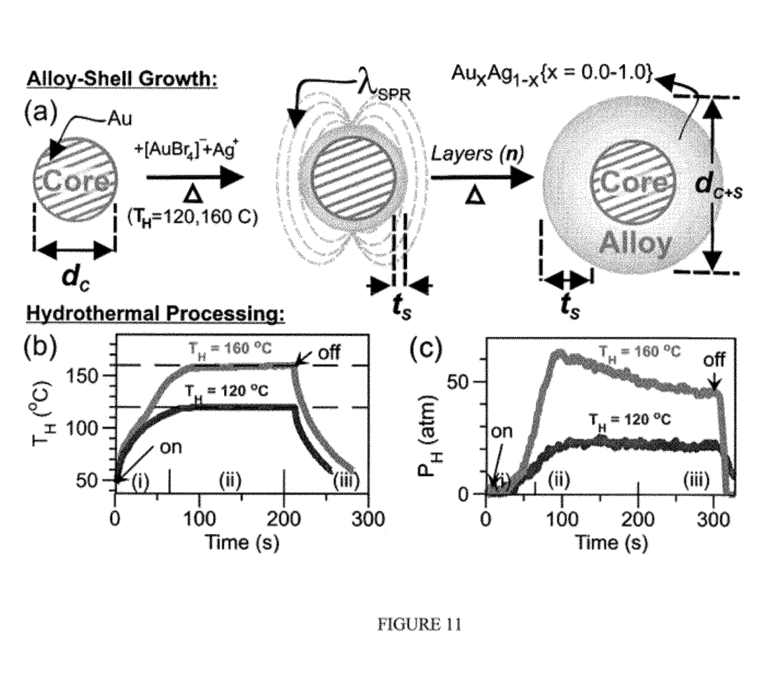

The present invention involves a hydrothermal layer-by-layer processing method to fabricate a binary Au/AuₓAg₁₋ₓ core/alloy system. The AuₓAg₁₋ₓ was chosen as a model to explore this approach in large part to the constituents miscible binary phase diagram, and rich plasmonic behavior. FIG. 11a shows an illustration of this approach.

Pre-synthesized AuNP are combined with known feed ratios of alloying components, which in this proof-of-principle study are [AuBr₄]⁻ and AgNO₃. The [AuBr₄]⁻ complex was chosen in order to have similar redox potentials between the precursors with the Au⁰ NP interface (E⁰≈0.858V). This feed ratio (r=[Ag⁺]+[AuBr₄]⁻/[AuNP]) is limited to that required to grow only a 0.25-0.5 nm thick shell (t_{S}). This process is then repeated for n-layers. To promote reduction, as well as alloy annealing, a novel hydrothermal temperature (T_{H}) processing method was employed that exploits automated microwave irradiation (MWI) for rapid and controllable dielectric heating. The use of a synthetic MW reactor for dynamic MWI facilitates fine-control of heating rate, cooling rates, processing temperature, as well as in-situ monitoring of reaction temperature (FIG. 11b) and pressure (FIG. 11c).

Beginning with Au cores synthesized as described above, shells of Ag and Au are deposited in controllable sub nanometer layers (n). Here, silver and gold reduction is achieved using a minimum amount of reducing agent, sodium citrate (Cit), which was found only to reduce silver and gold ions at the hydrothermal temperatures. Moreover, silver and gold ions are added and reduced in a step-by-step (e.g. layer-by-layer) fashion at a ratio (r=[Ag⁺+AuBr₄⁻]/[Au]) required to deposit a 0.25˜0.50 nm thick shell (T_{S}), based on model calculations for volume change and Au diameter and concentration. For example, in a typical experiment, a 2.2 mL ultrapure water (18.2 MΩ) solution of Au ([Au]=9.3 nM), trisodium citrate ([Cit]=1.36 mM), AgNO₃ ([AgNO₃]=0.045 mM)), and NaAuBr₄ ([AuBr₄⁻]=0.045 mM are hermetically sealed in 10 mL glass microwave reaction vessels. Next, the sample is rapidly heated to hydrothermal temperatures (T_{H}) and pressures (P_{H}) using computer controlled microwave irradiation (MWI). A typical reaction time is 3 minutes.

After each layer deposition (heating cycle), a 100 uL aliquot was collected for UV-vis and TEM analysis, and a fresh 100 uL aliquot of 1 mM AgNO₃ and 1 mM NaAuBr₄ are added in different ratio while maintained the volume at 100 uL. The process is then repeated an n number of times, resulting in the growth of the Ag+Au-rich core/shell nanostructure (Au/AuₓAg₁₋ₓ). When heated at different temperatures for 3 min we observed a colorimetric change from the ruby-red color of the 15 nm Au to a reddish-orange after only one layer (n=1), then gradually to orange at n=3-5. Ultimately, the color changed to (a) yellow at increased shell thickness (n=10) for x=0.15 and remained red for x=0.85 at 120° C. and (b) yellowish orange at increased shell thickness (n=10) for x=0.15 and remained reddish for x=0.85 at 160° C. The final Au/AuₓAg₁₋ₓ products were stored in the reaction mother liquor, and protected from light. Under these storage conditions, the Au/AuₓAg₁₋ₓ NPs were stable indefinitely.

Beginning with an aqueous dispersion of AuNP cores (d_{C}=15.4±0.7 nm), shells of AuₓAg₁₋ₓ alloys with x=0.0, 0.15, 0.50, 0.85, 1.0, are deposited in controllable shell thicknesses (t_{S}). After processing at T_{H}=120 or 160° C., a highly controllable and unique optical surface plasmon resonance (SPR) emerges as a function of x, t_{S}, and T_{H}. The SPR of a core-shell nanomaterial is derived from the size, shape, structure, composition, and surrounding medium of the nanostructure, thus making Au/AuₓAg₁₋ₓ an attractive test case. To follow these optical and morphology changes, UV-visible spectrophotometry (UV-vis) and transmission electron microscopy (TEM) was used.

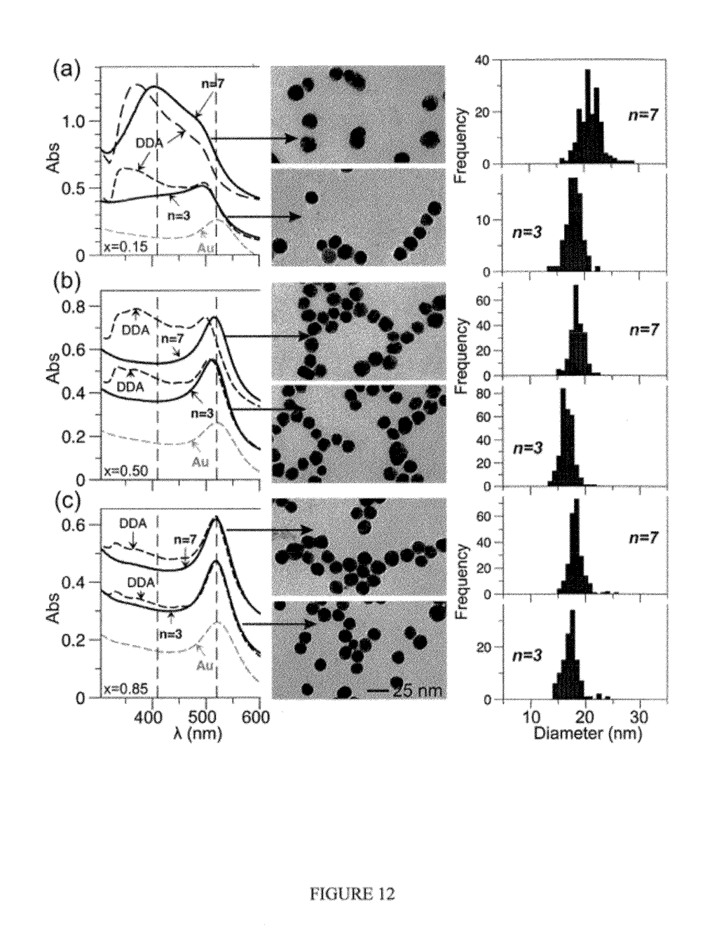

FIG. 12 shows a representative set of UV-vis and TEM results for the Au/AuₓAg₁₋ₓ system at T_{H}=120° C. and x=0.15 (a), 0.50 (b), and 0.85 (c). For example, at x=0.15 (a) we observe a systematic blue shift in λ_{SPR} from the AuNP at 520 nm to 490 nm at n=3, and a broad SPR further shifted to 405 nm at n=7. Such a blue-shift in SPR is indicated of an increasingly Ag-rich nanostructure. The corresponding TEM results at n=3 and 7 are shown in FIG. 12a. Two observations can be made. First, the overall morphology of the core/alloy NPs remains largely unchanged (e.g. spherical), and secondly an increase in core+shell diameter, d_{C+S}=16.7±1.8 nm, and 21.2±2.0 nm is observed.

A unique shift in SPR as a function of shell composition (x) was observed. For example, at x=0.50 (FIG. 12b) a less dramatic blue-shift is observed, with final λ_{SPR}≈500 nm. This λ_{SPR} was maintained despite an increase in d_{C+S} to 16.7±1.8 (n=3) and 18.6±1.2 nm (n=7). At x=0.85 (FIG. 12c), a near static λ_{SPR} 520 nm is observed despite increase in d_{C+S} to 17.3±1.6 (n=3) and 18.3±1.4 nm (n=7). These results strongly suggest the formation of alloy shells, with more Ag-rich shells showing blue-shifted SPR. Evidence for alloy growth was further demonstrated by X-ray photoelectron spectroscopy (XPS), which showed alloy stoichiometries in agreement with feed ratios (Table S1).

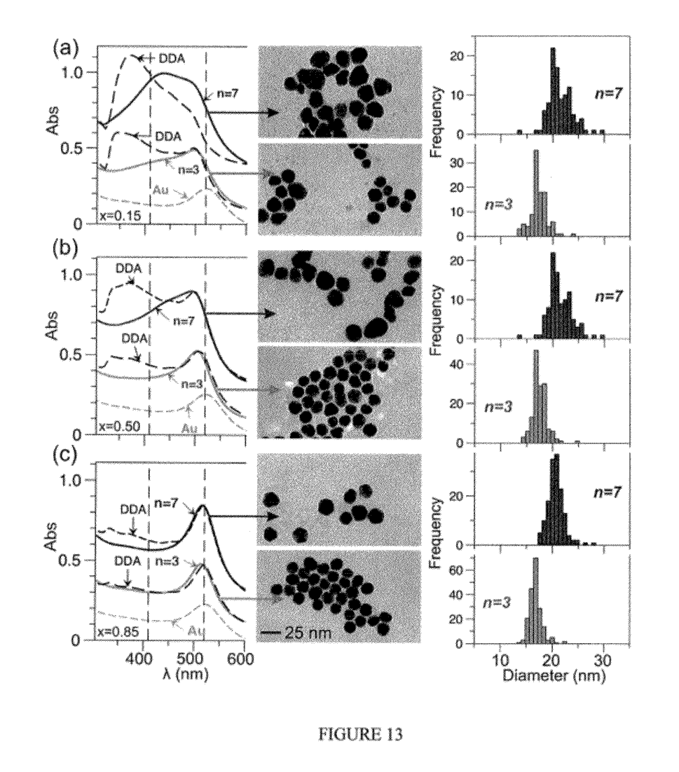

The effect of T_{H} on both alloy shell growth and composition control was investigated by performing identical experiments at T_{H}=160° C. (FIG. 13). At T_{H}=160° C., a more systematic d_{C+S} growth across the x range was observed, as well as a more thorough tailoring of λ_{SPR}. For example, at x=0.50 (FIG. 13b) we observe a new λ_{SPR} at 490 nm at n=3 and 405 nm at n=7. Shell growth was confirmed by TEM, which reveals d_{C+S}=17.6±1.3 and 20.4±2.0 nm at n=3 and 7 respectively. The SPR behavior was tuned to high energy at x=0.15 (FIG. 13a), and maintained at λ_{SPR} for x=0.85 (FIG. 13c).

These results show that a blue-shift in SPR is clearly possible by increasing the Ag-content in a shell of controlled thickness. However, another interesting aspect of the invention is the ability to maintain the SPR characteristics of a NP at low Ag-content despite an increase in d_{C+S}. For example, FIG. 13c shows the results for shell growth of composition x=0.85 that shows a near constant λ_{SPR}≈520 nm despite growth to d_{C+S}=16.8±1.3 (n=3) and 20.7±1.6 nm (n=7). Alloy formation was confirmed via XPS (Table S1). This suggests that a core/alloy NP may be used for tailoring λ_{SPR} energy, but also to maintain a λ_{SPR} of choice independent of NP diameter, a first such example.

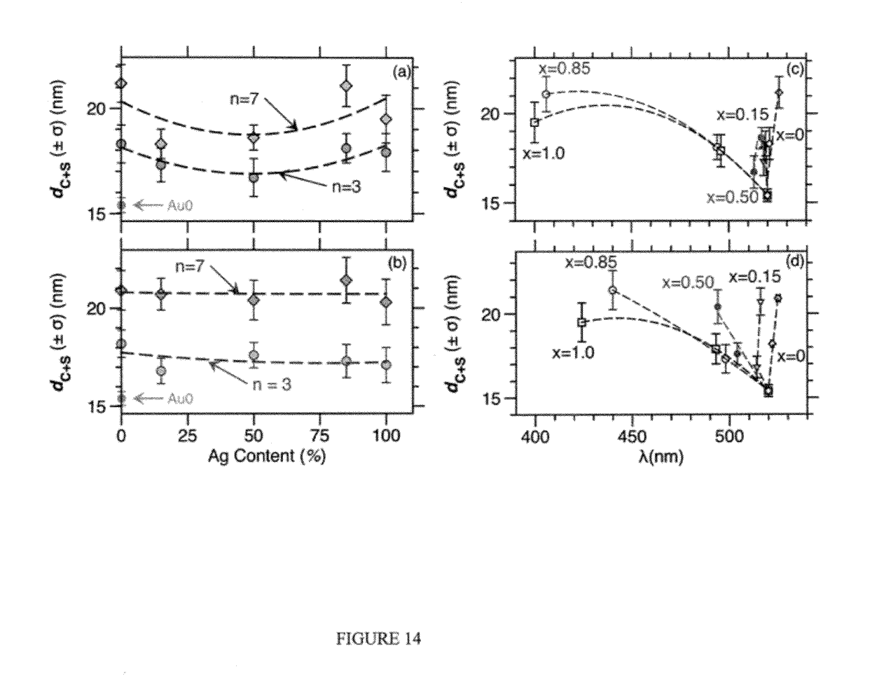

FIG. 14 summarizes these results by comparing d_{C+S} growth as a function of x for T_{H}=120 (a) and 160° C. (b). While both temperatures are shown effective at tailoring d_{C+S} increase, the NPs processed at 160° C. show remarkably consistent values, which suggest uniform shell thickness, allowing for better comparison of SPR and alloy-shell composition. A similar comparison can be made for the tunability of λ_{SPR}, as shown in FIG. 14 for 120° C. (c) and 160° C. (d). For instance, at T_{H}=160° C., the λ_{SPR} is shown to be highly tunable based on alloy x and d_{C+S}. It is important to note, that such control of SPR is in contrast to the growth of a larger AuNP, which shows a red-shift with increasing d_{C+S} (FIG. 14, x=0.0). Moreover, these findings suggest the ability to largely maintain a near constant λ_{SPR} at x=0.5-0.15.

Clearly, these results suggest that the SPR character can be tailored by the addition of AuₓAg₁₋ₓ shells. To further investigate this, the SPR was compared to a model core/alloy architecture using the discrete dipole approximation method (DDA). To model a core/alloy NP for the first time with DDA, we closely followed the TEM observed dimensions by utilizing a AuNP core (d=15.0 nm), with shells of thickness t_{S}=1.0 or 3.0 nm, and x=0.85, 0.50, and 0.15. For this, linear combinations of the alloys dielectric values were utilized, namely: ∈_{Alloy}(x,λ)=x_{Ag}∈_{Ag}(λ)+(1−x_{Ag})∈_{Au}(λ); where x_{Ag} is the volume fraction of Ag, and ∈_{Au} and ∈_{Ag} are dielectric constants for Au and Ag respectively. The results of the simulations are shown as dashed lines in FIGS. 12 and 13 with the corresponding experimental SPR. In general, the trends observed by DDA closely correlate with the SPR, reinforcing the case for alloy shell growth. However, at low x values (increasing Ag-content) discrepencies can be observed. In particular, the differences between the SPR at T_{H}=120 (FIG. 12a) and 160° C. (FIG. 13a) at n=7 cannot be modeled by this simple DDA approach. We believe the reason for this to be an increased alloy interdiffusion from core-to-shell at higher T_{H}. For instance, the shell content is likely of increased x (from core), or a thicker alloy shell is created (core size decreases). Thus, the alloy is likely highly gradient in nature. Such diffusion may be enhanced by local heating at the nanoparticle interface due to the use of MWI. We are currently exploring this phenomena in more detail.

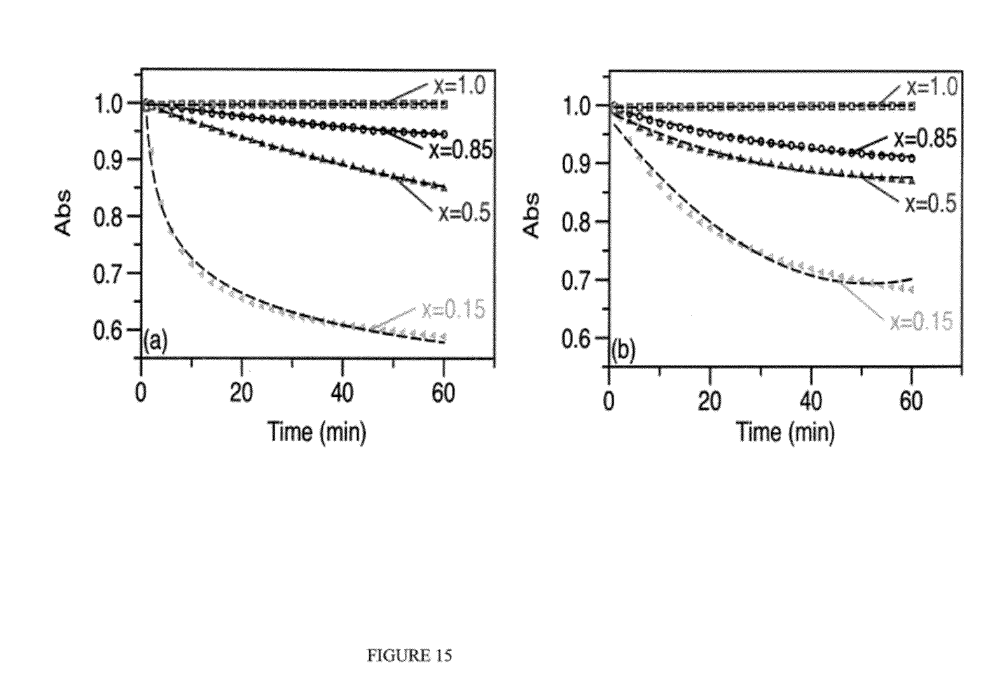

Chemical means were used to decipher the core/alloy structure of the NPs. For this, the ligand bis(p-sulfonatophenyl)phenylphosphine (BSPP) was used. BSPP is known to oxidize Ag but not Au. When added at high concentration ratios ([BSPP]/[NP]>100,000), the etching kinetics is thus dependent on x. Interestingly, this reaction results in an SPR trends that are very close to the reverse of the layer-by-layer growth. FIG. 15 shows a temporal plot monitoring the decrease in shell SPR due to BSPP etching for samples prepared at T_{H}=120 (a) and 160° C. (b). As shown in the trends, as x increases (e.g., decreasing Ag-content) the etching is less pronounced, indicating an increased alloy content of the shell itself. Such a decrease in SPR was correlated with shell etching by TEM, which revealed decrease in d_{C+S}.

### Example 3

From the studies discussed above, the utility of the core/alloy nanoparticle approach by the layer-by-layer deposition and alloying of Pd shells at Au NP cores (FIG. 11a) was demonstrated. Alloy formation, and subsequent interdiffusion is thermally activated using a novel microwave irradiation (MWI) based hydrothermal processing method. The use of a synthetic MWI reactor (Discovery-S, CEM Inc.) facilitates the automated and high-throughput control of heating and cooling rates, processing temperatures (T_{H}), as well as provides a means to monitor in-situ reaction temperature and pressure (FIG. 11e-f).

Layer-by-Layer Au₁Pd₁₋ₓ Alloy Shell Growth: To the Au cores synthesized above, alloy shells with sub nanometer thick layers (n) were deposited. The palladium ([PdCl₄]²⁻) and gold [AuCl₄]⁻) reduction is achieved using a minimum amount of reducing agent, sodium citrate (Cit), which was found only to reduce palladium and gold ions at the hydrothermal temperatures. Moreover, the precursor ions are added and reduced in a layer-by-layer fashion at a ratio (r=[AuCl₄⁻]+[PdCl₄²⁻]/[Au]) required to deposit a 0.25˜0.50 nm thick shell (t_{S}), based on model calculations for volume change and Au diameter and concentration. The alloy shell feed ratio was used to estimate alloy composition (x=[AuCl₄⁻]/[AuCl₄⁻]+[PdCl₄²⁻]) in the text. Actual compositions were measured via XPS and EDX (see below).

In a typical experiment, a 2.2 mL ultrapure water (18.2 MΩ) solution of Au ([Au]=9.3 nM), trisodium citrate ([Cit]=1.36 mM), HAuCl₄ ([AuCl₄⁻]=0.045 mM)), and Na₂PdCl₄ ([PdCl₄²⁻]=0.045 mM are hermetically sealed in 10 mL glass microwave reaction vessels. Next, the sample is rapidly heated to hydrothermal temperatures (T_{H}) and pressures (P_{H}) using computer controlled microwave irradiation (MWI). A typical reaction time is 3 minutes. After each layer deposition (heating cycle), a 100 uL aliquot was collected for UV-vis and TEM analysis, and a fresh 100 uL aliquot of 1 mM HAuCl₄ and 1 mM Na₂PdCl₄ are added in different ratio while maintained the volume at 100 uL. The process is then repeated an n number of times, resulting in the growth of the Pd+Au-rich core/shell nanostructure (Au/AuₓPd₁₋ₓ). Between cycles, the Au/AuₓPd₁₋ₓ NPs were not purified. When heated at different temperatures for 3 min we observed a colorimetric change from the ruby-red color of the 14 nm Au to a pinkish after only one layer (n=1), then gradually to purplish brown at n=3-5. Ultimately, the color changed to (a) brownish at increased shell thickness (n=10) for x=0.25 and maroon for x=0.75 at 120° C. Similar results were obtained at 160° C. The final Au/AuₓPd₁₋ₓ products were stored in the reaction mother liquor, and protected from light. Under these storage conditions, the Au/AuₓPd₁₋ₓ NPs were stable indefinitely.

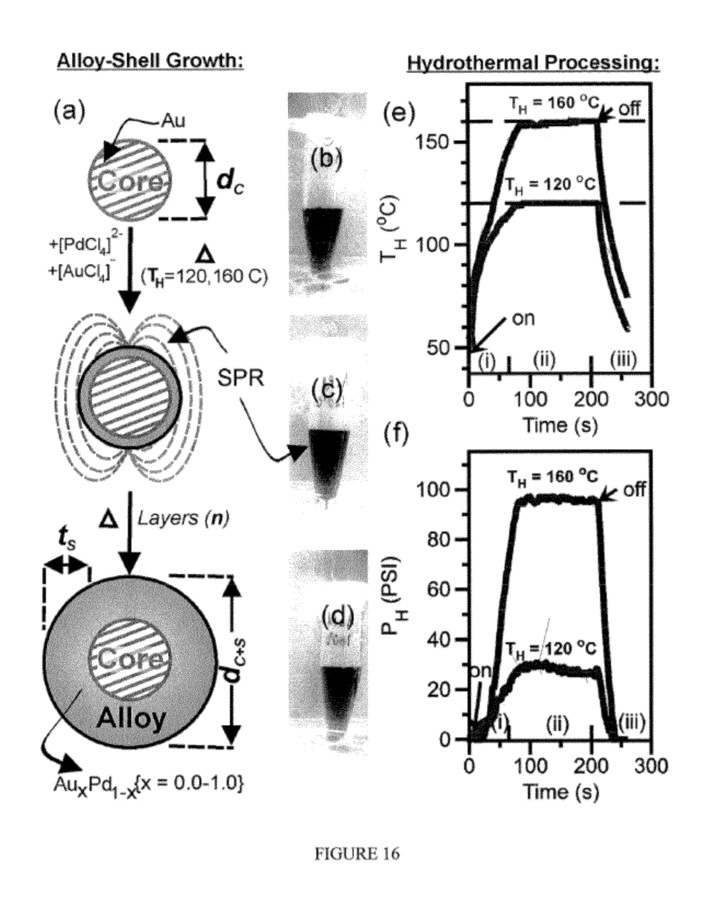

In the present invention, the AuPd binary alloy was chosen as a model due in large part to a miscible phase diagram, and differences between Au and Pd SPR signatures, which allows for colorimetric observation of shell or alloy growth (FIG. 16b-d).

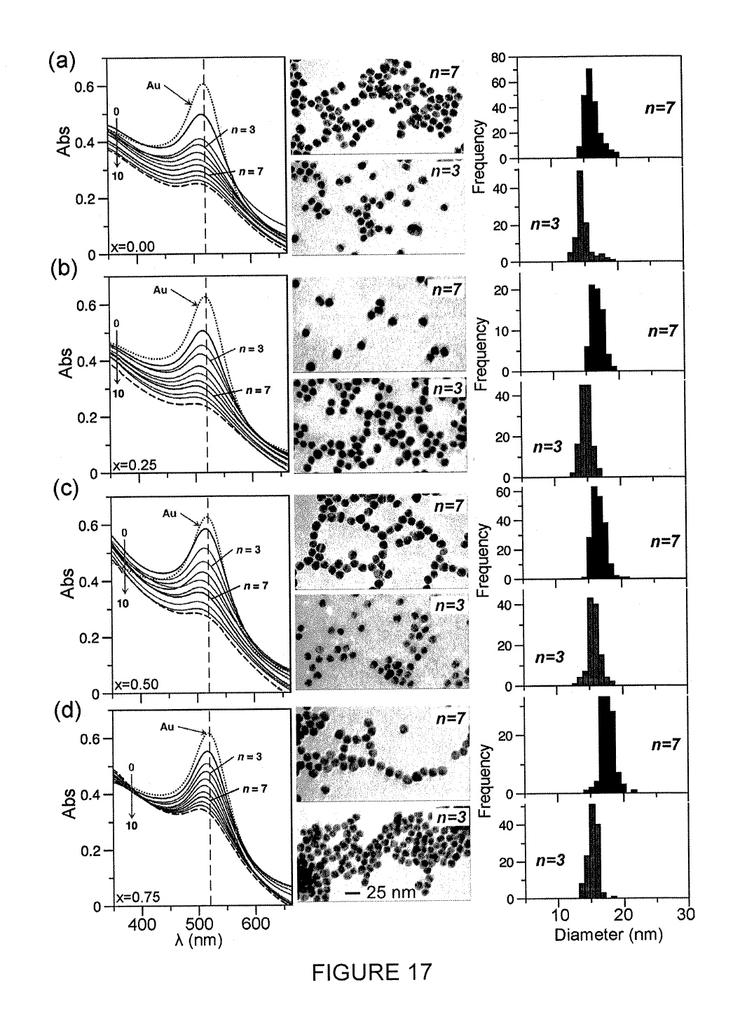

The processing approach is illustrated in FIG. 16a. A pre-synthesized Au NP core with diameter, d_{C}=13.6±0.7 nm, is used as a seed upon which deposition of layers (n) of AuₓPd₁₋ₓ (x=0.0, 0.25, 0.50, 0.75, 1.0) alloys occurs. The palladium and gold ions are added and reduced in a layer-by-layer fashion at a ratio (r=([AuCl₄⁻]+[PdCl₄²⁻])/[Au]) required to deposit only a 0.25˜0.50 nm thick shell (t_{S}). The value of r is based on model calculations for volume change, core d_{C}, and Au NP molar concentration [Au]. The shell precursor feed ratio is used to represent alloy shell composition (x). As a result of shell growth, a unique SPR response emerges as a function of x, t_{S}, and T_{H} (FIG. 17b-d), the origins of which was probed by UV-visible spectrophotometry (UV-vis), transmission electron microscopy (TEM), scanning TEM (STEM), X-ray photoelectron spectroscopy (XPS) and Energy Dispersive X-ray Spectroscopy (EDX).

FIG. 17 shows a representative set of UV-vis and TEM results for the Au/AuₓPd₁₋ₓ system at T_{H}=120° C. and x=0.0 (a), 0.25 (b), 0.50 (c), and 0.75 (d). We observe two main trends from the results. First, the NP SPR is noticeably dampened (decreased extinction) as n increases from n=1-10, presumably due to increased Pd content. It is important to note that the colloidal solutions maintained optical clarity, but changed color from red (Au) to brown/black (Au/Pd), suggesting the stability of the NPs. A second feature is the small SPR signature present at λ_{SPR}=520 nm at increased x (Au content) at n=10 (dashed lines). Such a SPR is indicative of the successful deposition of a AuₓPd₁₋ₓ alloy shell (vide infra). The shell growth was confirmed via TEM (FIG. 12), which showed the overall morphology of the NPs largely unchanged (e.g. spherical), with increase in core+shell diameters (d_{C+S}) proportional to n. For example, at x=0.00 (FIG. 12a), a d_{C+S}=14.8±1.2, and 16.4±1.2 nm is measured at n=3 and 7 respectively (FIG. 12a).

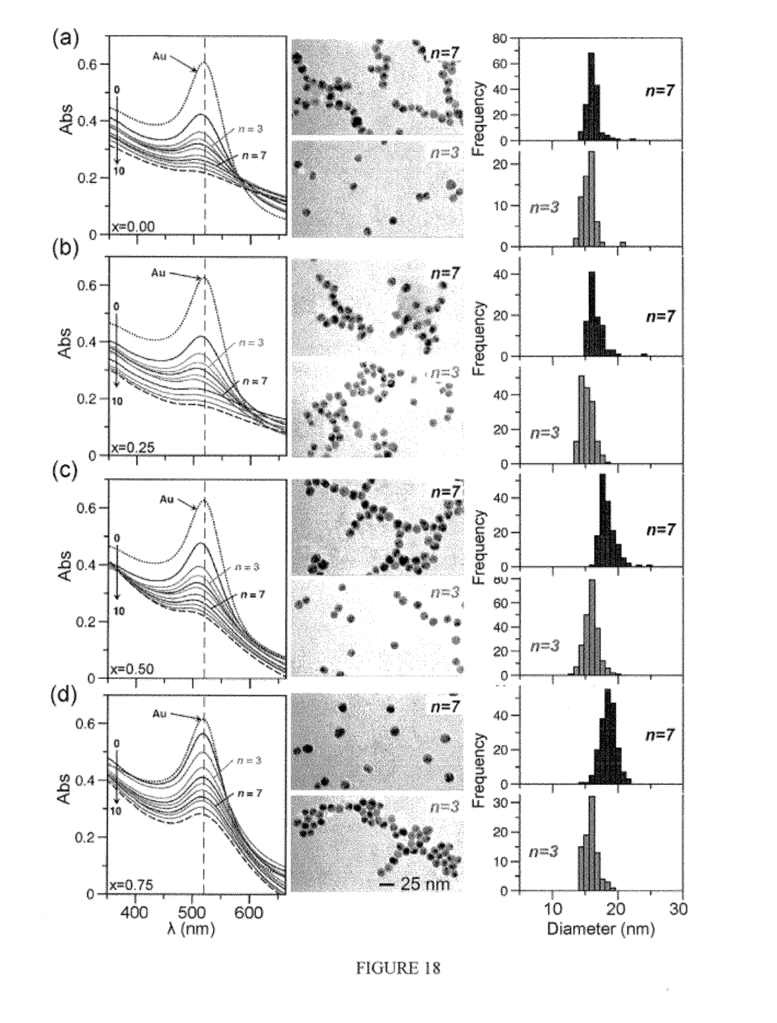

The dependance of shell growth on T_{H} was investigated next. FIG. 18 shows the UV-vis and TEM results for an identical Au/AuₓPd₁₋ₓ system but processed at the elevated T_{H}=160° C. When compared to T_{H}=120° C. (FIG. 12), SPR progression that is largely similar is observed. However, upon close inspection we observe two main differences. First, the SPR dampening as a function of n occurs at a faster rate, suggesting a thicker and more thorough shell deposition. Second, we observe the more complete attenuation of the SPR at x=0.00-0.50. For example, FIG. 18a shows the results of shell deposition at x=0.00 (pure Pd). Compared to the T_{H}=120° C. case (FIG. 17a), the SPR extinction decrease is ˜2× faster, and the final SPR at n=10 is noticeably flatter, corresponding to a black colloidal color (dashed line), suggesting a thicker Pd-shell. Analysis via TEM, revealed d_{C+S}=15.6±1.1, and 16.3±1.0 nm, at n=3 and 7 respectively. A similar set of trends was observed for the alloy shells at x=0.25 (b), 0.50 (c), and 0.75 (d). A comparison of d_{C+S} values for each x and T_{H} demonstrates the uniform shell growth.

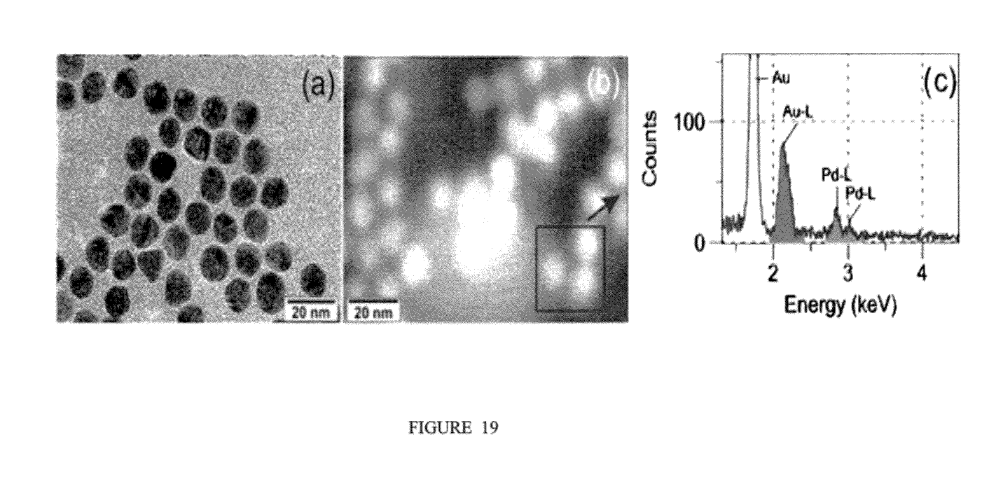

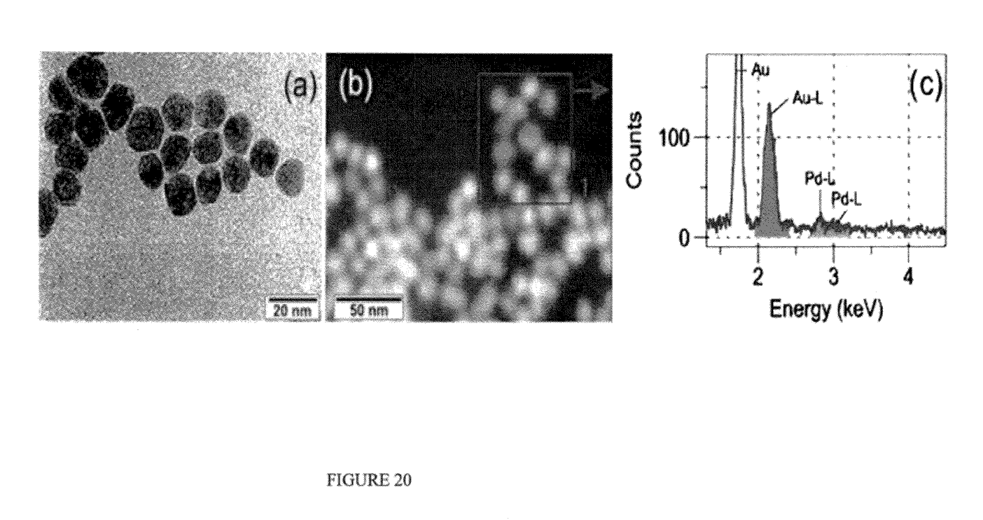

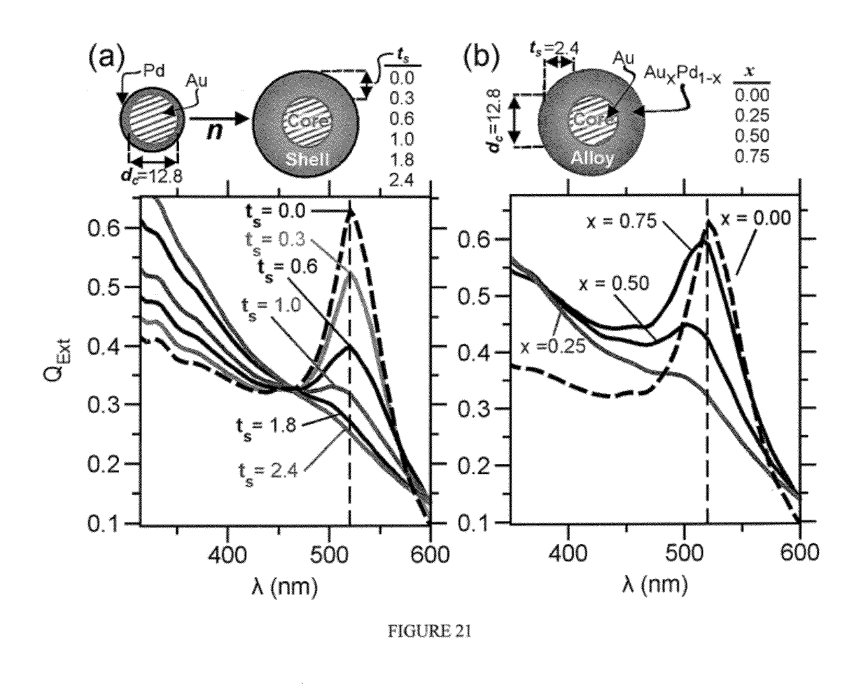

The NP composition change was probed by XPS, STEM and EDX. The XPS results indicated Pd content to increase with feed ratio, shell thickness (n), and T_{H} (FIG. 19-20). The HRTEM and STEM results indicated the NPs have uniform morphology, and lack of segregated core/shell structure. The EDX also indicated increased Pd content with feed ratios, and uniform compositions across a sample.

One advantage of the present invention is the ability to attenuate the SPR intensity and absorption character of the Au NP by addition of AuₓPd₁₋ₓ shells. While TEM and XPS characterize the overall morphology and composition as a whole, it is still challenging to correlate the SPR to individual NP ultrastructure (t_{S}, x, etc.).

For this, the observed SPR was compared to a model core/alloy architecture using the discrete dipole approximation method (DDA). Using the sizes determined by TEM, a Au core (d=12.8 nm) with conentric Pd shells (x=0) at t_{S}=0.0-2.4 nm was simulated. The DDA results shown in FIG. 18a predict the systematic dampening of the Au SPR at λ_{SPR}□=520 nm, and an increase in extinction at higher energies, λ_{SPR} □<450 nm, as a result of an increasingly thick shell of Pd. This trend corresponds closely with the experimental results for x=0.00 prepared at both T_{H}=120 (FIG. 12a), and 160° C. (FIG. 13a).

A similar simulation for a core/alloy architecture is shown in FIG. 14b. Here, a Au/AuₓPd₁₋ₓNP was simulated at a constant alloy thickness (t_{S}=2.4 nm) and compositions of x=0.00, 0.25, 0.50, and 0.75. For this, linear combinations of the alloys dielectric values were utilized, namely: ∈_{Alloy}(x,λ)=x_{Pd}∈_{Pd}(λ)+(1−x_{Pd})∈_{Au}(λ); where x_{Pd} is the volume fraction of Pd, and ∈_{Au} and ∈_{Pd} are dielectric constants for Au and Pd respectively. The characteristic feature of this simulation is the slight blue-shift in l_{SPR}, and decreased extinction (Q_{Ext}) as x is decreased from x=0.75-0.25. Again the results strongly agree with the experimental results shown above. Taken together, these DDA simulations reaffirm the conclusion of successful deposition of AuPd alloys at pre-synthesized Au NP cores.

In summary, the present invention comprises a new approach towards the processing of core/alloy NPs with optical SPR that can be tailored by both shell thickness and alloy composition. The plasmon response itself provides valuable insights into the particle ultrastructure. Such high-fidelity control of SPR and morphology may find utility in plasmonic antenna, catalysis, and surface enhanced Raman substrates.

What is claimed is:

1. A method for synthesizing core/alloy nanostructures, comprising the steps of:
forming at least one core having a diameter between 2 and 100 nanometers from a first metal;
suspending said core in an aqueous solution containing a second metal;
heating said aqueous solution at least a first time to form a shell of said second metal around said core that interdiffuses with said first metal thereby forming an alloy.

2. The method of claim 1, wherein said first metal is gold and said second metal is silver.

3. The method of claim 1, wherein said first metal is gold and said second metal is palladium.

4. The method of claim 1, further comprising the step of heating said aqueous solution additional times to form additional shells of said second metal around said core.

5. The method of claim 4, wherein said additional shells comprise a mixture of gold and said second metal in each shell, wherein said second metal is silver or palladium.

6. The method of claim 1, wherein the step of forming at least one core having a diameter between 2 and 100 nanometers from a first metal comprises the steps of:
heating a solution of a metal acid;
adding a reducing agent;
cooling the solution;
annealing the solution
stirring until said at least one core forms with the desired diameter.

7. The method of claim 6, wherein the metal acid is HAuCl₄.

8. The method of claim 7, wherein the reducing agent is trisodium citrate.

9. The method of claim 8, wherein said solution of HAuCl₄ is heated to about 95 degrees Celsius and then cooled to 80 degrees Celsius after said trisodium citrate is added.

10. The method of claim 1, wherein the step of suspending said core in an aqueous solution containing a second metal comprises sealing a solution containing said at least one core, a reducing agent, and said second metal in a reaction vessel.

11. The method of claim 1, wherein the step of heating said aqueous solution to form a shell of said second metal around said core comprises the step of rapidly heating said solution in said reaction vessel to a predetermined temperature and pressure using microwave irradiation to deposit a predetermined thickness of said second metal onto said core.

12. The method of claim 11, wherein said predetermined temperature is at least 90 degrees Celsius.

13. The method of claim 12, further comprising the step of allowing said aqueous solution to cool below said 90 degrees Celsius.

14. The method of claim 11, further comprising the step of heating said aqueous solution at least a second time to deposit at least a second shell of a second predetermined thickness around said core.

15. A metal alloy nanoparticle, comprising:
a core of a first metal having a diameter between 2 and 100 nanometers;
at least a first shell of a second material surrounding said core and having a subnanometer thickness;
wherein said first metal is interdiffused with said second metal.

16. The nanoparticle of claim 15, wherein said first metal is gold and said second metal is silver.

17. The nanoparticle of claim 16, wherein said first metal is gold and said second metal is palladium.

18. The nanoparticle of claim 15, further comprising a plurality of shells of said second material surrounding said core.

19. The nanoparticle of claim 18, wherein said plurality of shells comprise a mixture of gold and silver in each shell.

20. The nanoparticle of claim 15, wherein said subnanometer thickness is between about 0.25 and 0.50 nanometers.
